(19) United States
(12) Patent Application Publication
(10) Pub. No.: US 2022/0335246 A1
(43) Pub. Date: Oct. 20, 2022

(54) System And Method For Video Processing

(71) Applicant: AIVIE TECHNOLOGIES SDN. BHD., Kuala Lumpur (MY)

(72) Inventors: Wan Mohd Faiz BIN W MOHAMAD FABLILLAH, Bandar Baru Sentul (MY); Mohamad Zaim BIN AWANG PON, Cyberjaya (MY)

(21) Appl. No.: 17/353,524

(22) Filed: Jun. 21, 2021

(30) Foreign Application Priority Data
Apr. 20, 2021 (MY) PI2021002134

(51) Int. Cl. G06K 9/00; G06N 3/04; G06N 20/00; G06T 5/40

(52) U.S. Cl. CPC G06K 9/00765; G06K 9/00751; G06K 9/00369; G06N 3/0454; G06N 20/00; G06T 5/40; G06K 9/00275; G06K 2009/00738

(57) ABSTRACT

The present invention relates to a system for video processing, wherein the system (10) comprises: an input unit (11), a processing unit (12) and an output unit (13). The input unit (11) inputs a video which includes one or more events defining a boundary of a respective scene within the video. The processing unit (12) processes the video to identify the event and insert a cue point at the boundary. The output unit (13) outputs the processed video. A method (20) for video processing is also disclosed.

### CROSS-REFERENCE TO RELATED APPLICATIONS

This application claims priority to Malaysian Patent Application No. PI2021002134, filed Apr. 20, 2021, which is hereby incorporated by reference in its entirety for all purposes.

### FIELD OF THE DISCLOSURE

The present invention relates broadly to the field of digital video processing. More particularly, the present invention relates to a system and method for video processing for automatically splitting a video into multiple short video clips.

### BACKGROUND

In the digital era, millions of videos are uploaded each day to online video sharing platforms such as YouTube, Dailymotion and the like. Since these platforms allow users to create channels, publish videos therein and earn revenue therefrom, many individuals are becoming independent video content creators to create and publish their own videos.

Since most of such channels are run by individuals, it is very difficult for those individual video content creators to perform in front of an imaging device e.g. video camera and mobile phone, to direct the video and to operate the imaging device. Therefore, the video content creators simply ‘switch on’ the imaging device to capture the entire sequence which includes many undesired shots which will not be included in the final video for uploading and actual shots that the video makers like to include in the final video for upload. Such undesired shots include error(s) by the performer, repetition of performances, undesired interruptions and the like.

Editing of such videos is a troublesome and time-consuming process for individual video content creators and therefore they easily get discouraged from continuing making such content. In order to simplify the editing process, the video content creators follow an approach of marking starting and/or ending of a shot, good shots, bad shots, repeated shots while performing in front of the imaging device, wherein they make some kind of signs e.g. gestures, actions, sign cards, etc. However, the editing process still needs a lot of time and labor to come up with a final video ready for uploading.

U.S. Pat. No. 9,800,949 B2 discloses a system and method for presenting advertising data during trick play command execution, wherein a video data stream is analyzed using pattern recognition and motion detection software to identify objects e.g. baseball batter, batters box, football, in the video data stream, relationship therebetween e.g. sports formation, and/or movements thereof e.g. moving golf ball, to determine a start and end of a scene within the video data stream. This system is very effective in detecting standard objects, patterns and movements. However, it may be very difficult to adopting this system in editing videos that do not include standard objects, patterns or movements.

Hence, there is still a need in the art fora system and method for video processing for accurate detection of scenes within a video and automatically splitting the video scene-by-scene. Furthermore, there is a need in the art for automatically editing live video feeds.

### SUMMARY

The present disclosure proposes a system and a method for video processing. The system comprises an input unit, a processing unit and an output unit. The input unit inputs a video, wherein the video includes two or more scenes and a beginning and/or an end of each scene is defined by an event within the video. The processing unit processes the video to identify the event and inserts a cue point at the beginning and/or end of each scene. The output unit outputs the processed video.

In one aspect of the present invention, the processing unit includes a machine learning (ML) module trained for predicting the event, wherein the event is a gesture, long pause, scene change and/or content change. The ML module predicts the event by recognizing on one or more signs in the video. Furthermore, the processing unit splits the video into multiple short video clips based on the cue point.

The method comprises the steps of: inputting a video at an input unit, processing the video at a processing unit and outputting the processed video at an output unit. The video includes two or more scenes and a beginning and/or an end of each scene is defined by an event within the video, wherein the event is at least one of a gesture, long pause, scene change and content change. The video is processed to identify the event and insert a cue point at the beginning and/or end. Furthermore, the video is processed by predicting the event using a machine learning (ML) module.

By this way, the present invention is capable of accurate detection of scenes within a video including non-standard objects, patterns or movement scenes and automatically splits the video scene-by-scene in a faster and easy manner. Furthermore, the events are predicted using the ML module, and therefore the present invention allows automatic editing of live video feeds.

Various objects, features, aspects and advantages of the inventive subject matter will become more apparent from the following detailed description of preferred embodiments, along with the accompanying drawing figures in which like numerals represent like components.

### BRIEF DESCRIPTION OF THE ACCOMPANYING DRAWINGS

In the figures, similar components and/or features may have the same reference numerals. Further, various components of the same type may be distinguished by following the reference numerals with a second numeral that distinguishes among the similar components. If only the first reference numeral is used in the specification, the description is applicable to any one of the similar components having the same first reference numeral irrespective of the second reference numeral.

FIG. 1 shows a block diagram of the system for video processing, in accordance with a first embodiment of the present invention.

FIG. 2 shows a schematic representation of timeline of a video and time points of events therein, in accordance with an exemplary embodiment of the present invention.

FIG. 3 shows a schematic representation of timeline of a video and time points of events therein, in accordance with an alternate embodiment of the present invention.

FIG. 4 shows a flow diagram of the method for video processing, in accordance with an exemplary embodiment of the present invention.

FIG. 5 shows a block representation of the system for video processing, in accordance with a second embodiment of the present invention.

### DETAILED DESCRIPTION

In accordance with the present disclosure, there is provided a system and method for video processing, which will now be described with reference to the embodiments shown in the accompanying drawings. The embodiments do not limit the scope and ambit of the disclosure. The description relates purely to the embodiments and suggested applications thereof.

The embodiments herein and the various features and advantageous details thereof are explained with reference to the non-limiting embodiment in the following description. Descriptions of well-known components and processes are omitted so as to not unnecessarily obscure the embodiments herein. The examples used herein are intended merely to facilitate an understanding of ways in which the embodiments herein may be practiced and to further enable those of skill in the art to practice the embodiment herein. Accordingly, the description should not be construed as limiting the scope of the embodiment herein.

The description hereinafter, of the specific embodiment will so fully reveal the general nature of the embodiments herein that others can, by applying current knowledge, readily modify or adapt or perform both for various applications such specific embodiment without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Various terms as used herein are defined below. To the extent a term used in a claim is not defined below, it should be understood with the broadest definition given by persons in the pertinent art to that term as reflected in publications (e.g. dictionaries, article or published patent applications) and issued patents at the time of filing.

### Definitions

Video—A continuous sequence of image frames processed electronically into an analog or digital format with or without audio. Examples of video include but not limited to movie, TV video, CCTV footage, live footage, presentation video, advertisement video and documentary video.

Editing—Process of converting a raw video into a finished video ready for viewing by audience. This process includes selecting one or more portions of the raw video, removing unwanted portions, duplicating one or more selected portions, arranging the selected portions and/or duplicated portions in a desired order and/or combining the arranged portions into a single final video.

In accordance with an exemplary embodiment of the present invention, the system for video processing includes a machine learning (ML) module trained for predicting one or more events within a video, wherein a beginning and/or end of a scene is defined by the corresponding event, such that a cue point is inserted at the beginning and/or end of the scene. By this way, the present invention allows accurate detection of scenes within a video including non-standard objects, patterns or movements scenes and automatically splitting the video scene-by-scene in a faster and easy manner. Thereby, a user can mark beginning and/or end of the scene while making the video.

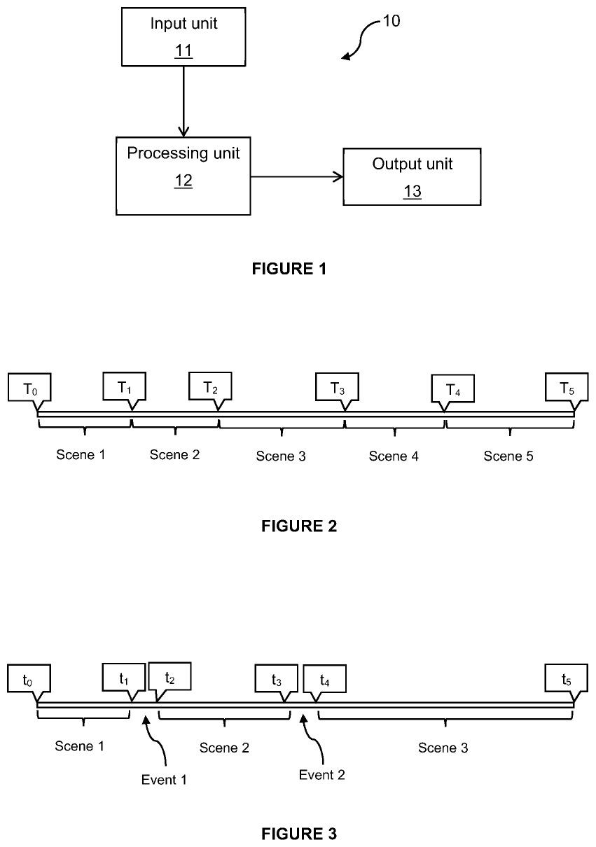

FIG. 1 shows a block representation of the system (10) for video processing, in accordance with a first embodiment of the present invention. The system (10) comprises an input unit (11), a processing unit (12) and an output unit (13). The input unit (11) may include but limited to an input interface, computing device such as desktop computer, laptop computer, tablet computer, personal digital assistant and mobile phone, home automation devices, burglar alarm devices, security gate system and an imaging device such as video camera, closed circuit television (CCTV) camera, mobile phone camera and web camera, connected to the computing device, home automation devices, burglar alarm devices and security gate system. The input unit (11) inputs a video by means of capturing video images or transferring video files from a storage device such as hard disk drive, flash drive device or any conventional portable storage device. Preferably, the input unit (11) inputs captured video as a live feed to the processing unit (12).

The video includes two or more scenes and a beginning or end of each scene is defined by an event. In a preferred embodiment, the event includes but not limited to gesture, long pause, auditory signal, scene change and content change. Gesture includes any kind of body movements e.g. finger gestures, postures, hand gestures, eye movements, lip movements, head movements, face expressions and the like. Auditory signal includes but not limited to utterance of any specific word, unwanted audible noise, playing music or any other sound produced by humans or objects.

The processing unit (12) processes the video to insert a cue point at the beginning and/or end of each scene, wherein a machine language (ML) module of the processing unit (12) is trained to predict the event by analyzing each of a set of frames in the video. Preferably, the ML module predicts the event by recognizing one or more signs within in the video. The ML module includes a ML model, preferably a deep learning model, more preferably a Siamese neural network (SNN) optimized using Contrastive Loss Function. Alternatively, the deep learning model is a Convolutional Neural Network (CNN) Long Short-Term Memory Network (LSTM)-based model.

Preferably, the ML module is trained using one or more video clips showing individual parts of body to recognize each event. For example, a set of pre-classified video clips showing lip movements for different words is used for training the ML module to recognize events related to lip movements. Alternatively, a set of video clips showing multiple body parts can be used for training the ML module. For example, pre-classified video clips showing entire upper body can be used for training, such that the ML module captures hand gestures, eye movements, head movements, facial expressions and upper body postures along with lip movements for recognizing each event.

After training, the ML module is automatically validated using a different set of video clips to determine a success rate of recognition by the ML module. Alternatively, each recognition by the ML module is manually validated to determine the success rate. If the success rate reaches a threshold, then the ML module is used for actual recognition process. Otherwise, the ML module is re-trained with another set of pre-classified video and then verified again to determine the success rate. The re-training process is continued until the success rate of the ML module reaches the threshold rate.

During the actual recognition process, the ML module identifies and extracts one or more features e.g. lips, eyes, face, head, hands, fingers, palms, voice, music and the like, in the video, wherein the ML module is trained for recognizing one or more signs e.g. clenched fist sign, peace sign, whole palm sign, etc., related to those features. From the extracted features, the ML module recognizes one or more signs for predicting an event. For example, the user may exhibit sudden face expressions, eye movements and/or cessation in voice, before uttering the word “Start” for indicating the beginning of event.

Furthermore, the processing unit (12) includes a marking module for inserting a cue point at the beginning or end of the scene, when the ML module predicts an occurrence of an event. By this way, the present invention allows accurate detection of scenes within a video including non-standard objects, patterns, auditory signal or movements scenes and automatically splitting the video scene-by-scene in a faster and easy manner. Thereby, a user can mark beginning and/or end of the scene while making the video.

Alternatively, when the input unit (11) inputs a pre-recorded video in the form of a video file, the processing unit (12) identifies one or more events captured in the video as a beginning or end of scenes in the video and inserts a cue point at the identified beginning and end of each scene before splitting the video into multiple short clips. Furthermore, the processing unit (12) selects one or more of the short clips based on one or more corresponding events for transmitting as the processed video to the output unit (13).

For example, suppose the ML module is trained to recognize a cross hand gesture as cancellation. During actual processing, if the ML module recognizes a cross hand gesture at the end of a scene, the processing unit (12) can be configured to discard the scene and select any remaining scenes in the video as the processed video for output by the output unit (13). By this way, the present invention further simplifies the video editing and compiling process for a user.

Furthermore, when processing a pre-recorded video, the processing unit (12) converts the video into a set of frames with corresponding timestamps and sampled a preconfigured sampling rate, wherein frames at equal intervals are selected. The processing unit (12) arranges the selected frames in sequence that is then analyzed for recognizing the event. For example, if a video is converted in to a frame sequence containing 37 frames, wherein an interval between adjacent frames is 0.034 seconds, and if sampled at a sampling rate of one frame per 0.5 seconds, then 3 frames will be selected from the sequence and arranged for being analyzed by the ML module. By this way, speed and accuracy of the recognition process are improved.

Optionally, before converting the video, a filtering module (not shown) in the processing unit (12) filters each of the frames in the video using a built-in image filtering function such as Histogram Equalizer available in Python package called OpenCV. This helps in further improving the event recognition process. A feature detection module (not shown) in the processing unit (12) extracts one or more regions of interest in each frame, wherein the regions of interest include body parts of a user appearing in the video, objects and the like. By this way, ML module only has to analyze the extracted regions of interest rather than analyzing the frames entirely. Furthermore, a compression module (not shown) in the processing unit (12) determines if quality (number of pixels) of each frame is greater than a preset threshold, and compresses high quality frames to minimize an amount of memory space required to process the frames and store the processed frames.

In a preferred embodiment, the marking module inserts a cue point at a time point at which a corresponding event is predicted to start occurring. For example, as shown in FIG. 2, T₀ and T₅ refer to beginning and end of the video, respectively, whereas T₁-T₄ refer to events 1-4 identified between the beginning and end of the video. Thus, the marking module inserts a cue point at T₁, such that a footage between T₀ and T₁ is defined as scene 1. Likewise, the marking module inserts cue points at T₂-T₅, such that a footage between T₁ and T₂ is defined as scene 2, a footage between T₂ and T₃ is defined as scene ₃, a footage between T₃ and T₄ is defined as scene 4 and a footage between T₄ and T₅ is defined as scene 5. Optionally, the processing unit (12) includes a splitting unit for splitting or duplicating each scene based on the corresponding time points T₀-T₅.

In an alternate embodiment, the marking module inserts a cue point at both starting and end time points of each event, such that the scenes can be easily separated from the events and combined to form a final video. For example, as shown in FIG. 3, T₀ and T₅ refer to beginning and end of the video, respectively, whereas T₁ and T₂ refer to a beginning and end of event 1, and T₃ and T₄ refer to a beginning and end of event 2. Thus, the marking module inserts a cue point at T₁-T₄, such that a footage between T₀ and T₁ is defined as scene 1, a footage between T₂ and T₃ is defined as scene 2 and a footage between T₄ and T₅ is defined as scene 3. Furthermore, the splitting unit splits or duplicates each scene based on the corresponding time points T₀ -T₅.

Additionally, the processing unit (12) may include a combining module for combining the scenes together to form the processed video. In alternate embodiment, the combining module allows a user to define an order in which the scenes need to be arranged before combining to form the processed video. In some other embodiments, the combining module automatically arranges the scenes based on analysis of the corresponding events. For example, the events may include gestures, auditory signaling or flashcard display for denoting corresponding scene number. By analyzing such events, the combining module automatically arranges and combines the scenes based on the order numbers obtained by such analysis.

Finally, the output unit (13) outputs the processed video, wherein processed video includes short video clips corresponding to the scenes. The output unit (13) may include but is not limited to an output interface, computing device such as desktop computer, laptop computer, tablet computer, personal digital assistant and mobile phone, home automation devices, burglar alarm devices, security gate system and a display device such as liquid crystal display (LCD), light emitting diode (LED) display and television, connected to the computing device, home automation devices, burglar alarm devices and security gate system. The output unit (13) outputs the processed video by means of playing the processed video or by transferring the processed video to the storage device.

Preferably, the input unit (11) and the output unit (13) are communicatively connected to the processing unit (12) through any conventional wired or wireless means. More preferably, the input unit (11) and the output unit (13) are parts of a single computing device e.g. desktop computer, laptop computer, tablet computer, personal digital assistant and mobile phone, communicatively connected to the processing unit (12) which is in the form of a remote server.

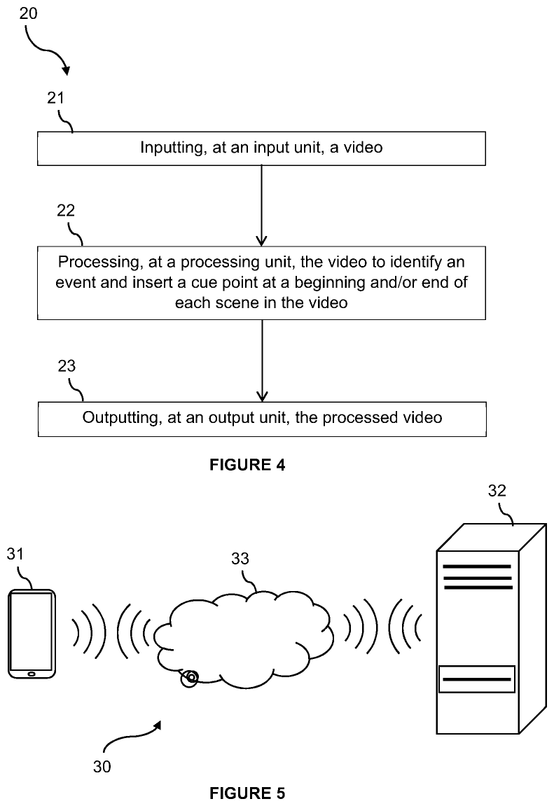

FIG. 4 shows a flow diagram of the method (20) for video processing, in accordance with an exemplary embodiment of the present invention. The method (20) comprises the steps of: inputting, at an input unit, a video (21) which includes two or more scenes, wherein a beginning and/or an end of each scene is defined by an event within the video, processing, at a processing unit, the video to insert a cue point at the beginning and/or the end (22), and then outputting, at an output unit, the processed video (23).

Preferably, the video is inputted by means of capturing video images using the input unit, wherein the input unit is in the form of a computing device such as desktop computer, laptop computer, tablet computer, personal digital assistant and mobile phone, home automation device, surveillance system, burglar alarm device, security gate system or an imaging device such as video camera, closed circuit television (CCTV) camera, mobile phone camera and web camera, connected to the computing device, home automation devices, surveillance system, burglar alarm devices and security gate system. Alternatively, the video is inputted by means of transferring video files from the input unit, wherein the input unit is in the form of a storage device such as hard disk drive, flash drive device or any conventional portable storage device.

In a preferred embodiment, the video is processed by analyzing each of a set of frames in the video using a machine learning (ML) module, predicting the beginning and/or end of each scene based on the analysis and inserting a cue point at each of the predicted beginning and/or end. The event includes but is not limited to a gesture, long pause, scene change, auditory signal and content change. Gesture includes any kind of body movements e.g. finger gestures, postures, hand gestures, eye movements, lip movements, head movements, face expressions and the like.

Preferably, the beginning and/or end of each scene is predicted by recognizing one or more signs within in the video using the ML module. The ML module includes a ML model, preferably a deep learning model, more preferably a Siamese neural network (SNN) optimized using Contrastive Loss Function. Alternatively, the deep learning model is a Convolutional Neural Network (CNN) Long Short-Term Memory Network (LSTM)-based model.

Preferably, the ML module is trained using one or more video clips showing individual parts of body to recognize each event. For example, a set of pre-classified video clips showing lip movements for different words is used for training the ML module to recognize events related to lip movements. Alternatively, a set of video clips showing multiple body parts can be used for training the ML module. For example, pre-classified video clips showing entire upper body can be used for training, such that the ML module captures hand gestures, eye movements, head movements, facial expressions and upper body postures along with lip movements for recognizing each event.

After training, the ML module is automatically validated using a different set of video clips to determine a success rate of recognition by the ML module. Alternatively, each recognition by the ML module is manually verified to determine the success rate. If the success rate reaches a threshold, then the ML module is used for actual recognition process. Otherwise, the ML module is re-trained with another set of pre-classified video and then verified again to determine the success rate. The re-training process is continued until the success rate of the ML module reaches the threshold rate.

During the actual recognition process, the ML module identifies and extracts one or more features e.g. lips, eyes, face, head, hands, fingers, palms, voice, music and the like, in the video, wherein the ML module is trained for recognizing one or more signs related to those features. From the extracted features, the ML module recognizes one or more signs for predicting an event. For example, the user may exhibit sudden face expressions, eye movements and/or cessation in voice, before uttering the word “Start” for indicating the beginning of event.

Furthermore, the cue points are inserted using a marking module in the processing unit. By this way, the present invention allows accurate detection of scenes within a video including non-standard objects, patterns, auditory signals or movements scenes and automatically splitting the video scene-by-scene in a faster and easy manner. Thereby, a user is allowed to mark beginning and/or end of the scene while making the video.

In a preferred embodiment, a cue point inserted by the marking module at a time point at which a corresponding event is predicted to start occurring. In an alternate embodiment, a cue point is inserted at each of starting and end time points of each event using the marking module, such that the scenes can be easily separated from the events and combined together to form a final video.

Furthermore, a user may be allowed to define an order in which the scenes need to be arranged before combining them to form the processed video. In some other embodiments, the scenes are automatically arranged based on analysis of the corresponding events. For example, the events may include gestures, auditory signaling or flashcard display for denoting corresponding scene number. By analyzing such events, the scenes are automatically arranged based on the order numbers obtained by such analysis and then combined to form the final processed video.

Finally, the processed video is outputted using the output unit, wherein the processed video includes short video clips corresponding to the scenes. The processed video is outputted by means of playing the processed video using a computing device such as desktop computer, laptop computer, tablet computer, personal digital assistant and mobile phone, home automation devices, burglar alarm devices, security gate system and a display device such as liquid crystal display (LCD), light emitting diode (LED) display and television, connected to the computing device, home automation devices, burglar alarm devices and security gate system, or by means transferring the processed video to the storage device using an output interface.

Alternatively, if the video is a pre-recorded video, the video is converted into a set of frames with corresponding timestamps and sampled at a preconfigured sampling rate, wherein frames at equal intervals are selected. The selected frames are arranged in a sequence which is then analyzed for recognizing the event. For example, if a video is converted in to a frame sequence containing 37 frames, wherein an interval between adjacent frames is 0.034 seconds, and if sampled at a sampling rate of one frame per 0.5 seconds, then 3 frames will be selected from the sequence and arranged for being analyzed by the ML module. By this way, speed and accuracy of the recognition process are improved.

Optionally, before converting the video, each of the frames in the video is filtered using a built-in image filtering function such as Histogram Equalizer available in Python package called OpenCV. This helps in further improving the event recognition process. One or more regions of interest in each frame is extracted, wherein the regions of interest include body parts of a user appearing in the video, objects and the like. By this way, ML module only has to analyze the extracted regions of interest rather than analyzing the frames entirely. Furthermore, each frame is checked if quality (number of pixels) of the frame is greater than a preset threshold, and is compressed if the quality is greater than the threshold to minimize an amount of memory space required to process the frames and store the processed frames.

FIG. 5 shows a block representation of the system (30) for video processing, in accordance with a second embodiment of the present invention. The system (30) comprises a mobile phone (31) and a processing unit (32) in wireless communication with one another. A wireless communication network (33) such as a wireless local area network (WLAN) and wide area network (WAN), wirelessly connects the mobile phone (31) and the processing unit (32) with one another. The mobile phone (31) includes one or more cameras capable of capturing a video, a display screen capable of displaying a video, and other common features available in any commercially available mobile phones. The video includes two or more segments, wherein a beginning and/or end of each segment is defined by an event. The event includes gesture, long pause, scene change and content change. Gesture may be any kind of body movements e.g. finger gestures, postures, hand gestures, eye movements, lip movements, head movements, face expressions and the like.

The processing unit (32) in the form of a remote server processes the video to insert a cue point at the beginning and/or end of each segment, wherein a machine language (ML) module in the processing unit (32) is trained to identify the event by analyzing each of a set of frames in the video. Preferably, the ML module identifies the event by recognizing one or more signs within in the video.

Furthermore, the processing unit (12) includes a marking module for inserting a cue point at the beginning or end of the scene, when the ML module identifies an occurrence of an event. By this way, the present invention allows accurate detection of scenes within a video including non-standard objects, patterns, auditory signals or movements scenes and automatically splitting the video scene-by-scene in a faster and easy manner. Thereby, a user can mark beginning and/or end of the scene while making the video.

Furthermore, the processing unit (32) transmits the processed video to the mobile phone (31), wherein the processed video includes a short video clip corresponding to each segment.

Optionally, the mobile phone (32) can be replaced with a video camera and a display device, wherein the video camera captures a video with two or more segments and the display device is capable of displaying a video. A beginning and/or an end of each segment is defined by an event within the video. The processing unit (22) communicates with the video camera for receiving and processing the video to insert a cue point at the beginning and/or the end. The processing unit (22) communicates with the display device for transmitting the processed video. Preferably, the processing unit (22) communicates with video camera and/or the display device by any conventional means of wireless or wired communication.

Furthermore, the machine learning (ML) module of the processing unit (12) is trained for identifying the beginning and/or end of each segment by analyzing each of a set of frames in the video. The event includes a gesture, auditory signal, long pause, scene change and/or content change.

Even though the above embodiments show the present invention as being applied for editing video footages for video makers, the present invention may also be used for processing videos of CCTV systems, traffic surveillance systems, border surveillance system and satellite surveillance systems to automatically mark short duration events in long duration videos and extracting video clips including the marked events. Thus, a need for a user to watch lengthy videos is avoided, while bringing all the events under the user's notice, which in turn saves time for the user.

The terminology used herein is for the purpose of describing particular example embodiments only and is not intended to be limiting. As used herein, the singular forms “a”, “an” and “the” may be intended to include the plural forms as well, unless the context clearly indicates otherwise.

The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups thereof.

The use of the expression “at least” or “at least one” suggests the use of one or more elements, as the use may be in one of the embodiments to achieve one or more of the desired objects or results.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A system (10) for video processing, comprising:
i. at least one input unit (11) for inputting a video, wherein said video includes at least two scenes and at least one of a beginning and an end of each scene is defined by an event within said video;
ii. at least one processing unit (12) for processing said video to insert a cue point at said beginning and/or said end; and
iii. at least one output unit (13) for outputting said processed video, characterized in that said processing unit (12) includes a machine learning, ML, module trained for predicting said beginning and/or said end of each scene by analyzing each of a set of frames in said video, wherein said event is at least one of a gesture, auditory signal, long pause, scene change and content change.

2. The system (10) of claim 1, wherein said ML module predicts said event by recognizing one or more signs within said video.

3. The system (10) of claim 1, wherein said processing unit (12) splits said video into multiple short video clips based on said cue point.

4. The system (10) of claim 1, wherein said input unit (11) is an imaging device selected from a group consisting of: video camera, closed circuit television camera, mobile phone camera and web camera.

5. The system (10) of claim 1, wherein said video is a live feed of video image captured by said imaging device.

6. The system (10) of claim 2, wherein said ML module recognizes said signs within said video by identifying and extracting one or more features within said video.

7. The system (10) of claim 6, wherein said features include at least one of lips, eyes, face, head, hands, fingers, palms, voice and music.

8. The system (10) of claim 1, wherein said ML module includes a Siamese neural network model or a Convolutional Neural Network Long Short-Term Memory network model for predicting said event.

9. The system (10) of claim 3, wherein said video is a pre-recorded video.

10. The system (10) of claim 9, wherein said processing unit (12) identifies one or more events captured in said video as a beginning or end of scenes in said video and inserts a cue point at said beginning and end of each scene before splitting said video into said short clips.

11. The system (10) of claim 9, wherein a filtering module in said processing unit (12) filters each frame in said video using a built-in image filtering function.

12. The system (10) of claim 11, wherein said built-in image filtering function includes Histogram Equalizer.

13. The system (10) of claim 11, wherein a feature detection module in the processing unit (12) extracts one or more regions of interest in each frame.

14. The system (10) of claim 13, wherein said regions of interest include at least one of body part and object.

15. The system (10) of claim 9, wherein said processing unit (12) converts said video into a set of frames with corresponding timestamps and samples said frames at a preconfigured sampling rate to select frames at equal intervals.

16. The system (10) of claim 15, wherein said processing unit (12) arranges said selected frames in a sequence and said ML module analyzes said sequence for recognizing said event.

17. The system (10) of claim 9 wherein a compression module in said processing unit (12) determines if a number of pixels of each frame in said video is greater than a preset threshold and compresses said frame if said number of pixels is greater than said threshold.

18. The system (10) of claim 3, wherein said processing unit (12) selects one or more of said short clips based on at least one corresponding event for transmitting as said processed video to said output unit (13).

19. A method (20) for video processing, comprising the steps of:
i. inputting, at at least one input unit, a video (21), wherein said video includes at least two scenes and at least one of a beginning and an end of each scene is defined by an event within said video;
ii. processing, at at least one processing unit, said video to insert a cue point at said beginning and/or said end (22);
iii. outputting, at at least one output unit, said processed video (23), characterized in that said step of processing includes:
a. analyzing each of a set of frames in said video using a machine learning, ML, module;
b. predicting said beginning and/or said end of each scene; and
c. inserting said cue point at said predicted beginning and/or end, wherein said event is at least one of a gesture, long pause, scene change and content change.

20. The method (20) of claim 19, wherein said step of processing includes splitting said video into multiple short video clips based on said cue point.

21. The method (20) of claim 19, wherein said step of predicting includes recognizing one or more signs within said video.

22. The method (20) of claim 19, wherein said step of recognizing includes identifying and extracting one or more features within said video.

23. The method (20) of claim 22, wherein said features include at least one of lips, eyes, face, head, hands, fingers, palms, voice and music.

24. The method (20) of claim 19, wherein said ML module includes a Siamese neural network or a Convolutional Neural Network Long Short-Term Memory network model for predicting said event.

25. A system (30) for video processing, essentially consisting of:
i. a mobile phone (31) with a camera capable of capturing a video with at least two segments and a display screen capable of displaying a video, wherein at least one of a beginning and an end of each segment is defined by an event within said video; and
ii. a processing unit (22) in wireless communication with said mobile phone (31) for receiving and processing said video to insert a cue point at said beginning and/or said end and for transmitting said processed video to said mobile phone (31),
characterized in that said processing unit (12) includes a machine learning, ML, module trained for identifying said beginning and/or said end of each segment by analyzing each of a set of frames in said video, wherein said event is at least one of a gesture, auditory signal, long pause, scene change and content change.

26. A system (30) for video processing, essentially consisting of:
i. a video camera for capturing a video with at least two segments, wherein at least one of a beginning and an end of each segment is defined by an event within said video;
ii. a display device capable of displaying a video; and
iii. a processing unit (22) capable communicating with said video camera for receiving and processing said video to insert a cue point at said beginning and/or said end and with said display device for transmitting said processed video,
characterized in that said processing unit (12) includes a machine learning, ML, module trained for identifying said beginning and/or said end of each segment by analyzing each of a set of frames in said video, wherein said event is at least one of a gesture, auditory signal, long pause, scene change and content change.
